(19) United States
(12) Patent Application Publication
(10) Pub. No.: US 2024/0262955 A1
(43) Pub. Date: Aug. 8, 2024

(54) POLYURETHANE BINDER SYSTEM USING BLOCKED ISOCYANATE

(71) Applicant: ASK Chemicals LLC, Wilmington, DE (US)

(72) Inventors: Sritama Kar, Dublin, OH (US); Shania Hayward, Columbus, OH (US)

(21) Appl. No.: 18/435,316

(22) Filed: Feb. 7, 2024

Related U.S. Application Data
(60) Provisional application No. 63/444,070, filed on Feb. 8, 2023.

(51) Int. Cl. C08G 18/80; B22C 1/22; C08G 18/72; C08G 18/76

(52) U.S. Cl. CPC C08G 18/8074; B22C 1/2273; C08G 18/721; C08G 18/7671; C08G 18/807

(57) ABSTRACT

A polyurethane system for use as a binder in producing foundry molds and cores in metal casting, especially in a “cold box” process, has a polyol component with one or more polyols having at least two OH groups per molecule, with at least one phenol resin, and an isocyanate component. Particularly, the isocyanate component includes a reaction product of at least one cyclic amine with at least one polyisocyanate having at least two NCO groups per molecule. Each cyclic amine is characterized as an amine having at least one NH— group and from four to six carbon atoms. Examples of the cyclic amine include ε-caprolactam and/or 3,5-dimethylpyrazole. Observed advantages include better humidity resistance and improved mold release properties.

### CROSS-REFERENCE TO RELATED APPLICATIONS

This application is a nonprovisional application that makes a priority claim to U.S. Provisional Application No. 63/444,070.

### TECHNICAL FIELD

The present application relates to polyurethane binder systems and, more particularly, to polyurethane binder systems that utilize one or more cyclic amines to thermally dissociatively block or “cap” the reactive sites on an isocyanate component.

### BACKGROUND ART

Within the foundry industry, two of the most important methods of sand casting for producing foundry molds are the polyurethane “cold box” and “no-bake” processes. Polyurethane binders are popular due to the high tensile strength, and high tunability and control of the time during which the foundry mix can be worked into molds.

In the “no-bake” process, also referred to a “PUNB,” a foundry mix is prepared by mixing an appropriate aggregate with the binder precursor components and a liquid curing catalyst. After forcing the foundry mix into a pattern, the curing of the foundry mix provides a foundry shape useful as a mold or core. In the “cold box” process, which is referred to as “PUCB” when the binder is a polyurethane binder, a foundry mix is prepared by mixing an appropriate refractory aggregate with the binder precursor components. After forcing the foundry mix into a pattern, a catalyst vapor is passed through the foundry mix, causing it to cure and provide a foundry shape useful as a mold or core. In other processes, namely, the “warm-box” and “hot-box” processes, the foundry mix is prepared by mixing the aggregate with a heat-reactive binder and catalyst. The foundry mix is shaped by forcing it into a heated pattern that causes the foundry mix to cure, providing a foundry shape useful as a mold or core.

Ashland Oil Inc., a predecessor of the applicant, was a leader in developing polyurethane binders over 50 years ago, as the owner of patents such as U.S. Pat. No. 3,676,392 to Robins. The general concepts involved in reacting a polyol resin, typically phenolic in nature, with an isocyanate are well-known, but the specifics are continually investigated to overcome known issues, such as the reactivity of the isocyanate component with moieties other than the polyol resin. One “bad actor” in this aspect is water vapor, resulting in the lack of humidity resistance in polyurethane binder systems.

As detailed below, an initial research effort focused on cardanol. U.S. Pat. No. 5,880,174, to Singh and assigned to Ashland, Inc., teaches reacting an aliphatic primary amine with the polyisocyanate component to be used in polyurethane binder, so that the binder system exhibits improved release from molds, increased humidity resistance and improved tensile strength. Positive results were obtained with isocetyl amine, isostearyl amine and oleyl amine. Each of these aliphatic primary amines has 16 or 18 carbon atoms.

U.S. Pat. No. 10,144,845 to Li, and assigned to Dow Global Technologies LLC, teaches the use of cardanol to modify a component of a polyurethane resin, but it is the polyol that is modified and not the isocyanate. Cardanol was seen to increase the biomass-derived composition of the polyol while achieving moisture tolerance and maintaining mechanical strength. The intended use was for filament windings and coating, not as a binder for foundry shapes to produce metal castings.

Keeping in mind that a foundry shape must meet minimum tensile strength standards in order to be commercially accepted, there are still unmet needs in providing a polyurethane binder system that can maintain tensile strength in a high humidity environment. It was found that by knowing how to selectively block the reactive isocyanate sites in a PUCB binder, the binder system may be “tuned” to allow for the longer working time needed to product larger foundry shapes.

### SUMMARY

This and other objectives are achieved by the features described below.

An isocyanate component of the inventive concept comprises a reaction product of at least one polyisocyanate with at least one cyclic amine. The polyisocyanate(s) has at least two NCO groups per molecule (before the reaction product is formed); and the cyclic amine(s) has at least one NH— group as part of the cyclic structure/cyclic ring and from four to six carbon atoms. Such amines may also be referred to as “bulky” amines.

In some embodiments, the isocyanate component is produced by reacting from about 10 to about 30 parts by weight of the polyisocyanate with 1 part by weight of the cyclic amine, and, preferably, from 15 to 25 parts by weight of the polyisocyanate with 1 part by weight of the cyclic amine.

In many of the embodiments, substantially all of the cyclic amine is reacted with more than 50% or more than 75% of the NCO groups of the polyisocyanate.

In many of the embodiments, the reaction product is produced in the presence of an aromatic solvent.

In many of the embodiments, the at least one amine comprises ε-caprolactam. In many embodiments, the at least one amine comprises 3,5-dimethylpyrazole. Mixtures of ε-caprolactam and 3,5-dimethylpyrazole may also be used.

Some inventive aspects are achieved by a polyurethane binder system that comprises a polyol component having one or more polyols with at least two OH groups per molecule, wherein the polyol component is or comprises a phenol resin; with the isocyanate component. The phenol resin is in particular a phenol formaldehyde resin and for example a resol.

Other aspects are achieved by a foundry mix composition that comprises a foundry aggregate and the polyurethane binder system, especially where the polyurethane binder system is present in the range of from about 1 to about 5 wt %, based on the foundry aggregate.

### BRIEF DESCRIPTION OF THE DRAWINGS

Some details of the detailed description will be best understood when reference is made to the following figures, in which:

FIG. 1 is a graphical depiction of the mold release properties of a PI-5 formulation when the isocyanate is blocked with a cyclic amine; and

FIG. 2 is a graphical depiction of the mold release properties of a PI-700 formulation when the isocyanate is blocked with a cyclic amine.

### DETAILED DESCRIPTION

### Abbreviations

The following abbreviations are used in the description that follows:
DMEA is N,N-Dimethylamine (CAS 598-56-1), a tertiary amine useful as a catalyst in PUCB binder systems;
DMIPA is N,N-Dimethylisopropylamine (CAS 996-35-0), a tertiary amine useful as a catalyst in PUCB binder systems;
DMPA is N,N-Dimethylpropylamine (CAS 926-63-6), a tertiary amine useful as a catalyst in PUCB binder systems;
TEA is triethylamine (CAS 122-44-6), a tertiary amine useful as a catalyst for PUCB binder systems;
ECap is ε-caprolactam, a cyclic amine described in more detail below that is commercially available, due to significant use in the production of Nylon 6;
HiSol-10 and HiSol-15 are aromatic solvents commercially available from Univar Solutions;
KCY blend is a commercially available blend of linseed oil with aromatic solvent;
MPCP is monophenyl dichlorophosphate (C₆H₅Cl₂O₂P, CAS 770-12-7), a commercially available phosphoric ester;
PI-5, also referred to as Polyisocyanate 5 is a liquid product having 31.0 to 33.0 wt. % isocyanate with a dynamic viscosity in the range of 40 to 85 mPa·s; an example of which would be MONDUR 1522, commercially available from Covestro; Mondur 1522 is a low to medium functionality polymeric based on diphenylmethane-diisocyanate (MDI) with a moderately high 2,4′-MDI isomer content;
PI-700, also referred to as Polyisocyanate 700, is a liquid product having 29 to 32 wt. % polyisocyanate, with a dynamic viscosity in the range of 600 to 800 mPa·s, an example of which would be MONDUR 489, commercially available from Covestro; Mondur 489 is a high-functionality polymeric diphenylmethane-diisocyanate (PMDI); and 3,5-DMP is 3,5-dimethylpyrazole, a cyclic amine described in more detail below.

### Cardanol

An initial research effort involved the possible use of cardanol as the blocking agent. Cardanol is a phenolic lipid that is derived from anacardic acid, a major component of the processing of cashew nutshells. This makes cardanol commercially attractive as a by-product from a non-food, non-fossil fuel resource. Cardanol (CAS 37330-39-5) can be characterized as a substituted phenol with an R group that has the formula C₁₅H₃₁₋ₙ, wherein n is 0, 2, 4 or 6, depending upon the degree of unsaturation. In the natural product, the tri-unsaturated product is the most common. Cardanol is a liquid at room temperature and boils at 225° C. (under reduced pressure of 10 mmHg). The average molecular weight is 340 g/mol. It is hydrophobic and is said to be comparable in its applications to nonylphenol, which is fossil fuel-based.

In addition to being renewably sourced from a natural product, cardanol was also an attractive candidate as a blocking agent because of its low viscosity, as well as the low temperature (150-200° C.) at which the cardanol could be thermally dissociated from the isocyanate.

Experimentally, however, the reaction of capping an isocyanate site with cardanol was not satisfactory, primarily due to the large ratio of cardanol to isocyanate required. Also, when tested against a control for bench life and tensile strength, the blocked isocyanate consistently underperformed. In a series of experiments, the level of completion of the reaction was monitored using FTIR and %-NCO titration. Reaction at room temperature provided only minimal blocking. When the reaction temperature was raised to the range of 50 to 60° C., partial blocking was obtained. However, obtaining a desired level of blocking required a molar ratio of cardanol to isocyanate ratio in the range of from 4:1 to 6:1. The presence of this excess free cardanol would then hinder the desired polyurethane formation with the polyol component of the binder. Also, when blocked with cardanol, the isocyanate developed an unacceptably high viscosity, requiring large amounts of solvent for blending with the polyol.

### 3,5-Dimethylpyrazole

Azoles are five-membered aromatic cyclic compounds containing a nitrogen atom and at least one other non-carbon atom, which can be nitrogen, sulfur or oxygen. When each of the one or more other non-carbon atoms are nitrogen, the one nitrogen that is not part of a double bond compound is an amine. Of the azoles, the imidazoles and pyrazoles have two nitrogens in the ring, there are two different triazoles with three nitrogens, there is one tetrazole with four nitrogens and pentazole has five nitrogens.

3,5-Dimethylpyrazole (CAS 67-51-6) is a substituted pyrazole with a chemical formula C₅H₈N2 and a molecular weight of 96.13 g/mol. It is a white solid at room temperature, melts at 107.5° C. and boils at 218° C.

Polyurethanes are based on urethane linkages, created by a reaction between a compound with a reactive hydroxyl group and a compound with an isocyanate group. To afford a blocked isocyanate, a cyclic amine such as 3,5-DMP or ECap is reacted with the isocyanate. Cyclic amines would appear to have an advantage over cardanol in that excess blocking agent will be minimized, since both of these cyclic amines are stoichiometric reagents that can be added based on known quantities. This may be beneficial for the curing step, where the Part I polyol has the potential to compete with the blocking agent.

For the PUCB binder, the blocked isocyanate is designed in a way so that the polymer chain contains a bulky leaving group (the cyclic amine blocking agents). The basicity of the blocking amines chosen are lower than the traditional amine catalysts as it allows for subsequent displacement by the traditional PUCB catalysts. This is significant because upon subsequent polyol Part I addition; it allows the formation of the polyurethane linkage by maintaining the reactivity of the standard polyol.

In the laboratory, a PI-5 polyisocyanate was shown to be blockable with 3,5-DMP, under heat in HiSol-15. Importantly, this reaction is highly reversible, so that the isocyanate groups can become unblocked during the curing stage

### ε-Caprolactam

Lactams are cyclic amides derived from an amino alkanoic acid, and the name “lactam” is a portmanteau of the words lactone and amide. The lactams have from 3 to seven atoms in the ring, with a Greek letter used to designate the number of atoms, with α-lactam having a 3-atom ring and ε-caprolactam having a seven-atom ring. As a lactam of caproic acid, ε-caprolactam (CAS 105-60-2) has the chemical formula C₆H₁₁NO and a molecular weight of 113.16 g/mol. It is a white solid at room temperature, melts at 69.2° C. and boils at 270.8° C. It is soluble in water. Because of its use as a raw material in Nylon 6, it is produced in large quantities annually.

### Cyclic Amines

As cyclic amines, 3,5-DMP and ECap are stoichiometric reagents that can be added as blocking agents based on known quantities. This allows the elimination of excess unreacted blocking agent, with the further result that, in the curing step, the Part I polyol does not have to compete with the blocking agent.

The cyclic amines are nucleophilic at the N atom. The Part I polyol is nucleophilic at the O atom. Because nitrogen is less electronegative than oxygen, nitrogen-based nucleophiles tend to be more reactive towards isocyanates than polyols, eventually reducing the reaction time.

### ECOCURE Binders

The ECOCURE family of phenolic polyurethane binders, commercially available from ASK Chemicals LLC, are used in the “cold box” process. While the ECOCURE product is available in more than one formulation, each member of the family is provided in two parts. Part I is a phenol-formaldehyde polyol component with appropriate additives and solvents. Part II is a polyisocyanate component, also with additives and solvents.

Exemplary of the ECOCURE family, and selected for the experimental work reported here, is the ECOCURE 358/658 binder system. In all of the work reported, the commercially available Part I ECOCURE 358 binder was used. The commercially available Part II ECOCURE 658 binder was used to provide a base for comparison, but experimental Part II components were formulated in the laboratory by substituting PI-5 polyisocyanate that has been blocked with either 3,5-DMP or Ecap.

The commercial ECOCURE 658 Part II binder component contains 65 wt. % PI-5 polyisocyanate, 30.6 wt. % organic solvent, 4 wt. % KCY blend and 0.4 wt. % of MPCP.

### Blocked ECOCURE Binders

To provide a proper experimental comparison, initial testing was made to establish at least one formulation of an ECOCURE 658 equivalent in which the isocyanate is blocked by either 3,5-DMP or Ecap, but the balance of the formulation remains the same.

The goal in the formulation is to replace the polyisocyanate from the Part II binder component with a blocked isocyanate. The other components remain the same as in ECOCURE 658 Part II.

### Preparation of Sand Cores

To conduct the bench life studies, 4000 parts by weight of a WEDRON 410 silica sand was mixed with a ECOCURE 358/658 binder system. The binder was added at 1.5 wt. %, based on the weight of the sand (“BOS”).

Once packed into cores, a PUCB core blower protocol needs to be followed. A typical blower protocol would be a blow time of 0.5 see, at a blow pressure of 40 psig, followed by an amine catalyst gas time of 1 sec. at 20 psig, using DMPA, and finally by an air purge time of 6 sec. at a purge pressure of 40 psig.

### Dilution Study

In initial work, 3,5-DMP was used as an exemplary blocking agent to produce a blocked isocyanate for comparison against an unblocked ECOCURE 658 Part II control composition. The blocked isocyanates were produced at three levels: 1 part blocking agent for each of 10, 15 and 30 parts of isocyanate. Although tensile strength data verified improved bench life for each formulation when compared to the control, duplicate cores within each formulation showed large standard deviations, so these data are not presented. In each case, 1.5 wt. % binder BOS was used with a 10-minute hot purge, 2 seconds of amine catalyst gassing, and 6 seconds of air purge.

As the 10-minute hot air purge, which was introduced with the intention of allowing the blocking agent to work, may have been too long, a further dilution study was conducted, in which the hot air purge was reduced to 6 minutes. Also, due to the consistent improvement over the control shown by the three levels of dilution, the 6-minute hot purge was conducted only at the level of 1 part blocking agent for 15 parts isocyanate. As before, 3,5-DMP was the blocking agent and DMPA was the catalyst.

In the 6-minute hot purge test the ECOCURE 358/658 system immediate resistance to humidity in the cores was seen, as was improved bench strength. However, large standard deviations between duplicate trials were noted, especially after 5 hours, as well as poorer bench life. This result was somewhat unexpected, but a possible explanation could be that the hot air purge was resulting in local areas of curing, instead of dissociative blocking, due to premature reaction between the polyol and the blocked isocyanate. As a consequence, experimentation moved forward by eliminating a hot air purge prior to the catalyst blow.

### Blocked PI-5 Test Formulations

A conventional ECOCURE 658 formulation has 95.6 wt. % PI-5 polyisocyanate, 4 wt. % KCY blend and 0.4 wt. % MPCP. In the data presented, this formulation will be referred to as E658-5.

Three modified formulations were prepared and tested. In each case, the PI-5 polyisocyanate portion was replaced with a blocked MDI formulation, with the amounts of KCY blend and MPCP remaining unchanged.

In the first modified formulation, referred to in the data as A25, the isocyanate was PI-5, present at a 25:1 weight ratio to 3,5-DMP as the blocking agent, as well as a balance of HiSol-10 solvent. This was achieved by combining 75.6 wt. % PI-5 with 3.03 wt. % 3,5-DMP, 16.97 wt. % HiSol-10, 4 wt. % KCY blend and 0.4 wt. % MPCP.

In the second modified formulation, referred to in the data as B15, the isocyanate was PI-5, present at a 15:1 weight ratio to Ecap as the blocking agent, as well as a balance of HiSol-10 solvent. This was achieved by combining 73.7 wt. % PI-5 with 4.93 wt. % Ecap, 16.97 wt. % HiSol-10, 4 wt. % KCY blend and 0.4 wt. % MPCP.

In the third modified formulation, referred to in the data as B25, the isocyanate was PI-5, present at a 25:1 weight ratio to Ecap as the blocking agent, as well as a balance of HiSol-10 solvent. This was achieved by combining 75.6 wt. % PI-5, 3.03 wt. % Ecap, 16.97 wt. % HiSol-10, 4 wt. % KCY blend and 0.4 wt. % MPCP.

TABLE 1
BLOCKED PI-5

| | E658-5 | A25 | B15 | B25 |
|---|---|---|---|---|
| Tensile Strength (psi) | | | | |
| 30 sec | 174 | 165 | 145 | 134 |
| 24 hrs @ 90° F., 90% RH | 122 | 151 | 152 | 159 |
| 1 hr | 184 | 171 | 159 | 140 |
| 1 hr, bench 24 hrs | 379 | 367 | 357 | 337 |
| 6 hrs | 113 | 120 | 115 | 106 |
| 6 hrs, bench 24 hrs | 225 | 249 | 233 | 217 |

The results from the E658-5 control formulation were generally as expected, including the loss in tensile strength when aged for 24 hrs in the 90° F., 90% relative humidity environment. While the formulations blocked with Ecap were somewhat disappointing when measured at 30 seconds and 1 hr, all three blocked formulations maintained tensile strength in the 24 hr test at high temperature and relative humidity. Overall, the polyisocyanate blocked with 3,5-DMP performed better than the polyisocyanate blocked with Ecap.

### Blocked PI-700 Test Formulations

A modified version of ECOCURE 658 formulated as a control was 78.06 wt. % PI-700 polyisocyanate, 17.54 wt. % HiSol-10, 4 wt. % KCY blend and 0.4 wt. % MPCP. In the data presented, this formulation will be referred to as E658-700.

Two modified formulations were prepared and tested. In each case, the PI-700 was replaced with a blocked MDI formulation, with the amounts of kerosene, KCY blend and MPCP remaining constant.

In the first modified formulation, referred to in the data as C₂₅, the isocyanate was PI-700, present at a 25:1 weight ratio to 3,5-DMP as the blocking agent, as well as a balance of HiSol-10 solvent. This was achieved by combining 75.6 wt. % PI-700, 16.97 wt. % HiSol-10, 3.03 wt. % 3,5-DMP, 4 wt. % KCY blend and 0.4 wt. % MPCP.

In the second modified formulation, referred to in the data as D25, the isocyanate was PI-700, present at a 25:1 weight ratio to Ecap as the blocking agent, as well as a balance of HiSol-10 solvent. This was achieved by combining 73.7 wt. % PI-700, 16.96 wt. % HiSol-10, 4.93 wt. % Ecap, 4 wt. % KCY blend and 0.4 wt. % MPCP.

TABLE 2
BLOCKED PI-700

| | E658-700 | C25 | D25 |
|---|---|---|---|
| Tensile Strength (psi) | | | |
| 30 sec | 220 | 194 | 202 |
| 24 hrs @ 90° F., 90% RH | 111 | 190 | 164 |
| 1 hr | 193 | 178 | 188 |
| 1 hr, bench 24 hrs | 328 | 312 | 326 |
| 6 hrs | 102 | 75 | 67 |
| 6 hrs, bench 24 hrs | 167 | 141 | 144 |

The data obtained in blocking PI-700 does not differ significantly from that obtained when blocking PI-5. The expected loss of tensile strength by the control formulation when in the high temperature, high relative humidity environment is largely ameliorated by the blocking agent.

### Amine Catalyst Testing

Four different amine catalysts—DMEA, DMIPA, DMPA, and TEA—were selected for comparison purposes to test their effectiveness with the blocked PI-700 modified E658-700 formulations C₂₅ and D25. It has been noted from this test that the improvement in humidity resistance of the blocked PI-700 modified E658-700 formulations appears to be independent of the type of the conventional amine catalyst used. Although experimental data are not presented, all four amines show equivalent improvement in humidity resistance while using blocked PI-700 modified E658-700 formulations C₂₅ and D25, when compared to the control formulation E658-700.

### Mold Release Properties

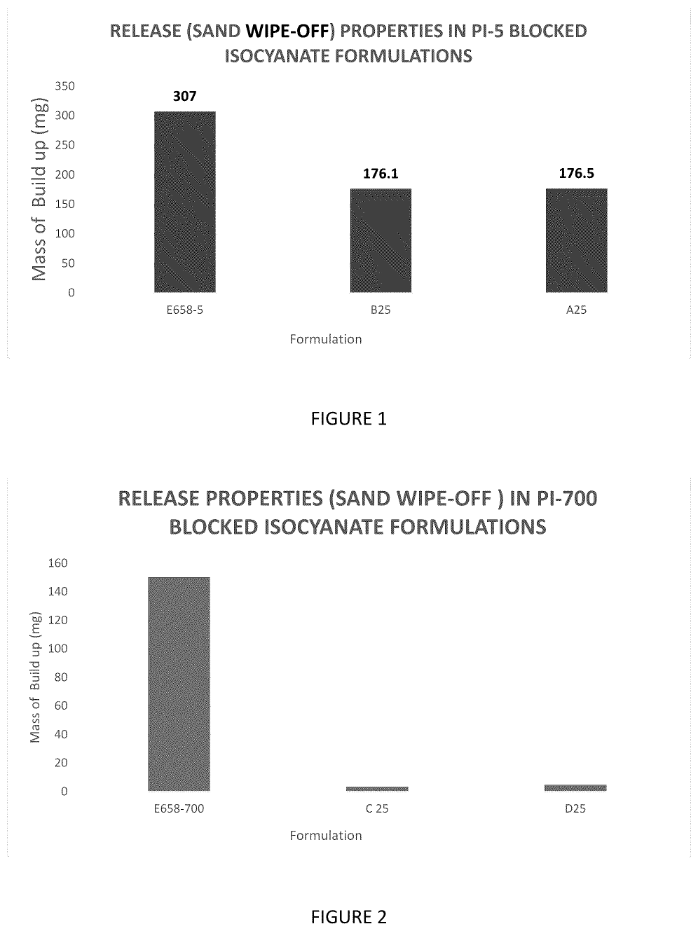

The blocked isocyanates were investigated for mold release or sand wipe-off properties. The mold release properties of PUCB binders are of high interest since sand build-up from running multiple cycles of core production in the same core blower can slow down productivity in the foundries. FIG. 1 graphically illustrates that more sand build-up occurs in the control E658-5 formulation than in the blocked PI-5 isocyanate formulations A25 or B25, which showed strikingly similar results.

The same test was conducted to compare the sand build-up from the control E658-700 formulation to that of the blocked PI-700 isocyanate formulations C25 or D25. Referring to FIG. 2, the reduction in build-up from the blocked PI-700 formulations C25 and D25 is even more notable than that seen in the PI-5 comparison.

What is claimed is:

1. An isocyanate component, comprising a reaction product of at least one polyisocyanate and at least one cyclic amine;
wherein each polyisocyanate has at least two NCO groups per molecule; and
wherein each cyclic amine comprises at least one NH— group and from four to six carbon atoms.

2. The isocyanate component of claim 1, wherein:
the isocyanate component is obtainable as the reaction product of about 10 to about 30 parts by weight of the at least one polyisocyanate with 1 part by weight of the at least one cyclic amine.

3. The isocyanate component of claim 1, wherein:
the isocyanate component obtainable as the reaction product of about 15 to about 25 parts by weight of the at least one polyisocyanate with 1 part by weight of the at least one cyclic amine.

4. The isocyanate component of claim 1, wherein:
the isocyanate component comprises 10 to 30 parts by weight of the polyisocyanate and 15 to 25 parts by weight of the at least one cyclic amine; and
at least part of the polyisocyanate and part of the at least one cyclic amine is in the form of the reaction product.

5. The isocyanate component of claim 1, wherein:
the reaction product is produced in the presence of an aromatic solvent.

6. The isocyanate component of claim 1, wherein the at least one cyclic amine comprises ε-caprolactam.

7. The isocyanate component of claim 1, wherein the at least one cyclic amine comprises 3,5-dimethylpyrazole.

8. A polyurethane binder system, comprising:
a polyol component having one or more polyols with at least two OH groups per molecule, wherein the polyol component comprises at least one phenol resin; and
the isocyanate component of claim 1.

9. A foundry mix composition, comprising:
a foundry aggregate; and
the polyurethane binder system of claim 8.

10. The foundry mix composition of claim 9, wherein:
the polyurethane binder system is present in an amount ranging from about 1 to about 5 wt. %, based on the foundry aggregate.
